(19) United States
(12) Patent Application Publication
(10) Pub. No.: US 2011/0147550 A1
(43) Pub. Date: Jun. 23, 2011

(54) Extracorporeal Blood Circuit Component Mounting System

(75) Inventors: Mark Wendler, St. Louis Park, MN (US); Al McLevish, Maple Grove, MN (US); Chris Plott, St. Paul, MN (US); Joe Cardinal, Brooklyn Park, MN (US); Mike Hobday, Lino Lakes, MN (US); Roderick Briscoe, Rogers, MN (US)

(73) Assignee: Medtronic, Inc., Minneapolis, MN (US)

(21) Appl. No.: 12/640,963

(22) Filed: Dec. 17, 2009

(51) Int. Cl. F16M 13/00; B23P 11/00

(52) U.S. Cl. 248/218.4; 29/428

(57) ABSTRACT

A mounting system for mounting one or more components of an extracorporeal blood circuit to an upstanding mast provided with a pump cart. The system includes a clamp device, a primary arm, a seat, a post, and a locking mechanism. The clamp device is mountable to the mast and pivotably maintaining the primary arm. The seat defines a tapering intermediate section and is mounted to the primary arm. The post projects from the seat. Finally, the locking mechanism is configured to releasably secure an extracorporeal circuit component, otherwise located over the seat, to the primary arm. With this configuration, the extracorporeal circuit component can be selectively located and locked to the primary arm at a variety of different rotational orientations. The mounting system can further include an auxiliary arm defining a sleeve sized to be removably disposed over the seat.

### BACKGROUND

The present disclosure relates to extracorporeal blood circuits, systems, and methods of use. More particularly, it relates to mounting systems for mounting one or more components of an extracorporeal blood circuit (blood reservoir, oxygenator, filter, etc.) relative to other components, such as to a cart maintaining one or more circuit pumps.

An extracorporeal blood circuit is commonly used during cardiopulmonary bypass to withdraw blood from the venous portion of the patient's circulation system (via a venous cannula) and return the blood to the arterial portion (via an atrial cannula). The extracorporeal circuit generally includes a venous drainage or return line, a venous blood reservoir, a venous blood pump, an arterial line, and blood transporting tubing, ports, and connection pieces interconnecting these components. Additional components, such as an oxygenator, a venous filter, an arterial filter, etc., are also commonly employed. Further, cardiotomy blood suctioned from the surgical site can be incorporated into the extracorporeal circuit (with appropriate filtering), and entails an additional pump and reservoir (that can be separate from, or integrated with, the venous blood reservoir). In addition to the venous blood and cardiotomy pumps, the cardiovascular surgical procedure may require additional pumps (e.g., cardioplegia pump, vent pump, etc.), as well as one or more back-up pumps in the event of failure.

Conventionally, the pumps as well as other non-disposable extracorporeal circuit components (e.g., controllers, monitors, etc.), are carried to and from the surgical suite by a wheeled console or cart for convenient storage, transport, and use. Other disposable components (e.g., blood reservoir, oxygenator, filter, etc.) are mounted to the cart as desired by the user (i.e., a perfusionist). More particularly, one or more upright poles or masts are provided with the cart, and the disposable components are mounted to the mast(s) in accordance with the procedure to be performed, a location of the patient and preferences of the user/perfusionist.

The physical arrangement of fluid lines, pumps, reservoir(s), oxygenator, and other components of the extracorporeal blood circuit directly affect proper operation of the perfusion system. It is generally considered important to have an arrangement that reduces the extracorporeal volume of all blood-containing circuits so as to reduce the need for transfusion or dilution. Additionally, the physical arrangement should be such that the perfusionist can scan, take samples, and consistently be aware of the status of all equipment, systems, and patient parameters. It is also highly desirable that the perfusionist be able to observe the surgical team and operating table, and to observe and have direct access to the oxygenator, the fluid lines, the pumps, the reservoirs, etc., from a single standing or sitting position.

While specialty brackets or other holders are available for connecting or mounting extracorporeal blood circuit disposable component(s) to the cart/mast, the brackets are typically unique to the design of the component in question, and even to a size of the particular component. For example, a pump cart mounting device for an adult-sized reservoir may not be compatible with a pediatric-sized reservoir from the same manufacturer. This in turn requires the perfusionist to have multiple holders on hand to accommodate differently-sized disposable components. Further, existing mounting systems may overtly limit arrangement of certain circuit components relative to one another. For example, extracorporeal blood circuits often entail both a reservoir and an oxygenator; some surgical site applications and/or perfusionist preferences will desirably position the oxygenator immediately below the reservoir while others employ an offset arrangement. Unfortunately, many existing mounting devices do not afford the perfusionist the ability to select a desired arrangement from procedure to procedure. Along these same lines, most pump carts provide two masts, one to the left of the pumps, and the other to the right. This facilitates use of the pump cart in a surgical suite to either side of the patient (i.e., where the surgical suite is established at the patient's left, the right mast is likely to be used for mounting of the disposable extracorporeal circuit components, and vice-versa). Existing holder designs (e.g., combination reservoir and oxygenator holders) do not readily permit both right side and left side mounting arrangements; instead, the perfusionist must have two different versions of the circuit component(s) in question on hand (e.g., a left side reservoir and a right side reservoir) to arrange the circuit as desired once the surgical suite constraints are known.

In light of the above, a need exists for an extracorporeal blood circuit mounting system for mounting one or more components to a pump cart mast.

### SUMMARY

Some aspects in accordance with principles of the present disclosure relate to a mounting system for mounting one or more components of an extracorporeal blood circuit to an upstanding mast provided with a cart otherwise maintaining one or more pumps employed with the extracorporeal blood circuit. The system includes a clamp device, a primary arm, a seat, a post, and a locking mechanism. The clamp device is configured for releasable mounting to an upstanding pole. The primary arm defines first and second end portions, with the first end portion being pivotably coupled to the clamp device. The seat defines a base, an intermediate section, and a head. The base is mounted to the second end portion of the primary arm. The intermediate section tapers in outer diameter from the base to the head, and is configured to receive a corresponding feature associated with an extracorporeal blood circuit component. The post projects from the head in a direction opposite the primary arm. Finally, the locking mechanism is configured to releasably secure a feature associated with an extracorporeal blood circuit component, otherwise located over the seat, to the primary arm. With this configuration, the extracorporeal blood circuit component can be selectively located and locked to the primary arm at a variety of different rotational orientations about an axis defined by the post. In some embodiments, the locking mechanism includes a spring biased lever forming a leading face having a plurality of transversely extending fingers, and provides a locked state in which a feature associated with an extracorporeal blood circuit component is captured by one or more of the fingers. In other embodiments, the mounting system further includes an auxiliary arm defining a leading region and a trailing region, with the trailing region forming a sleeve sized to be removably disposed over the intermediate section of the seat. In related embodiments, the leading region is configured to selectively receive and maintain an extracorporeal blood circuit component, such as an oxygenator.

Other aspects in accordance with principles of the present disclosure relate to an assembly for use in an extracorporeal blood circuit. The assembly includes a blood reservoir and a mounting system. The blood reservoir includes a housing forming a chamber and a mounting portion. The mounting portion defines a foot and a passage. In this regard, the passage is open at, and extends from, the foot. The mounting system includes a clamp device, a primary arm, a seat, a post, and a locking mechanism as described above. With this in mind, the assembly is configured to provide first and second locked states in which the post is received within the passage and the foot is locked over the seat via the locking mechanism. The blood reservoir can rotate relative to the primary arm about an axis of the post such that a spatial rotational location of the blood reservoir relative to the primary arm differs between the first and second locked states. In some embodiments, the mounting system further includes an auxiliary arm forming a sleeve and a grasping structure. The sleeve sized to be received over the post and the seat, with the grasping structure configured for selective coupling to an extracorporeal blood circuit component apart from the blood reservoir (e.g., an oxygenator, a filter, etc.). With this in mind, the assembly is configured to provide a stacked arrangement in which the sleeve is located directly over the seat, and the foot is received directly over the sleeve, with the locking mechanism operating to lock the blood reservoir and the auxiliary arm relative to the primary arm.

Yet other aspects in accordance with principles of the present disclosure relate to a method of arranging components of an extracorporeal blood circuit. The method includes coupling a clamp device of a mounting system to an upstanding mast provided with a cart otherwise maintaining at least one pump to be used in the extracorporeal blood circuit. The mounting system further include a primary arm pivotably coupled to the clamp device, a seat carried by the primary arm, a post projecting from the seat, and a locking mechanism. A blood reservoir is assembled to the mounting system. In this regard, the blood reservoir includes a housing forming a mounting section defining a foot and a passage open at, and extending from, the foot. Assembly of the blood reservoir to the mounting system includes sliding the passage over the post. The blood reservoir is rotated relative to the primary arm about an axis defined by the post to a desired spatial orientation. Finally, the blood reservoir is locked relative to the primary arm in the desired spatial orientation via operation of the locking mechanism. In some embodiments, the method further includes assembling a sleeve portion of an auxiliary arm over the post and onto the seat, followed by mounting of the foot over the post and onto the sleeve. A separate extracorporeal blood circuit component is mounted to a grasping structure of the auxiliary arm. The blood reservoir and the auxiliary arm are rotated about the post axis and thus relative to the primary arm in an independent fashion to desired spatial locations, and the locking mechanism operated to simultaneously lock the blood reservoir and the auxiliary arm relative to the primary arm.

### BRIEF DESCRIPTION OF THE DRAWINGS

FIG. 1 is a perspective view of an extracorporeal blood circuit perfusion assembly incorporating a component mounting system in accordance with principles of the present disclosure;

FIG. 2 is an exploded, perspective view of a holder assembly portion of the mounting system of FIG. 1;

FIG. 3 is a side view of the holder assembly of FIG. 2 upon final construction;

FIG. 4 is a bottom view of the holder assembly of FIG. 3;

FIG. 5 is an exploded, perspective view of an auxiliary arm portion of the mounting system of FIG. 1;

FIG. 6 is a perspective view of another auxiliary arm useful with the mounting system of FIG. 1 and maintaining an extracorporeal blood circuit component;

FIGS. 7A-7C are simplified top views of a surgical suite and illustrate arrangement of the mounting system of FIG. 1 relative to a pump cart;

FIG. 8A is a perspective view of the mounting system of FIG. 1 upon final assembly;

FIG. 8B is a cross-sectional view of the system of FIG. 8A;

FIGS. 9A and 9B are perspective views illustrating use of the mounting system of FIG. 1 to maintain an extracorporeal blood circuit component, such as an oxygenator;

FIG. 10A is a side view of a portion of the mounting system of FIG. 1 including two auxiliary arms;

FIG. 10B is a cross-sectional view of the arrangement of FIG. 10A;

FIG. 10C is a perspective view of the mounting system of FIG. 1 upon final construction and incorporating three auxiliary arms;

FIG. 11 is a simplified cross-sectional view of a blood reservoir useful with the mounting system of FIG. 1;

FIG. 12A is a side view of the blood reservoir of FIG. 11 assembled to the mounting system of FIG. 1;

FIG. 12B is a cross-sectional view of a portion of the assembly of FIG. 12A;

FIG. 13 is a side view of the blood reservoir of FIG. 11 and an additional extracorporeal blood circuit component assembled to the mounting system of FIG. 1; and

FIGS. 14A and 14B are perspective views illustrating variations in the spatial arrangements of the disposable components of FIG. 13.

### DETAILED DESCRIPTION

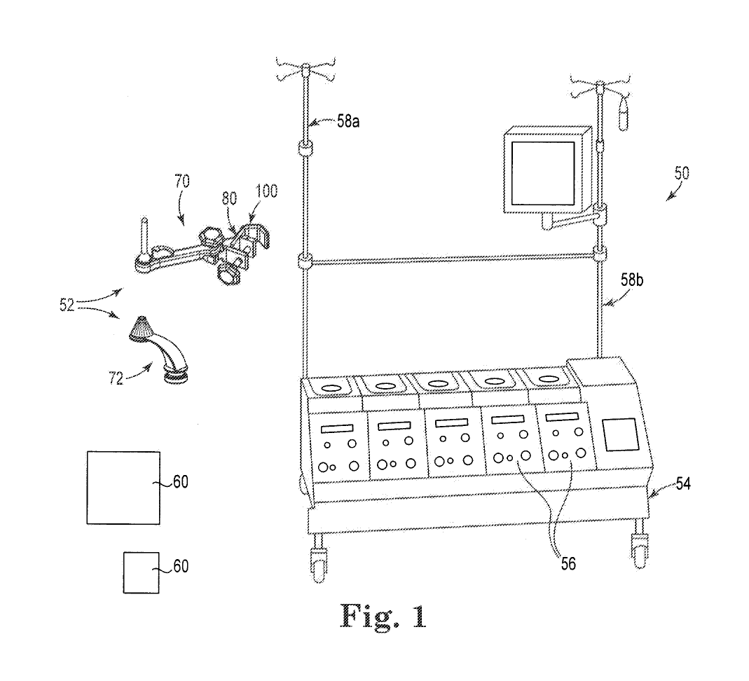

One embodiment of an extracorporeal blood circuit perfusion assembly 50 incorporating a mounting system 52 in accordance with principles of the disclosure is shown in FIG. 1. The assembly 50 can assume a variety of forms, and generally includes a cart 54 maintaining various components of the assembly 50 (e.g., one or more pumps 56), as well as one or more upright masts or poles 58. For example, relative to a front of the cart 54 (i.e., the side at which the pumps 56 and other non-disposable components, such as monitors, controllers, etc., are naturally interfaced by a user/perfusionist), the cart 54 maintains a left mast 58a and a right mast 58b. The mounting system 52 is employed by the perfusionist to selectively mount or couple one or more additional extracorporeal blood circuit components (referenced generally at 60) to one of the masts 58 as described below. In this regard, the components 60 can assume various forms useful in performing a perfusion procedure and are typically disposable, such as a blood reservoir, oxygenator, filter, etc.

The mounting system 52 includes a holder assembly 70 and optionally one or more auxiliary arms 72. The holder assembly 70 is configured for coupling to the selected mast 58, and can directly maintain one or more of the disposable components 60 and/or indirectly maintain one or more disposable components 60 via the auxiliary arm(s) 72.

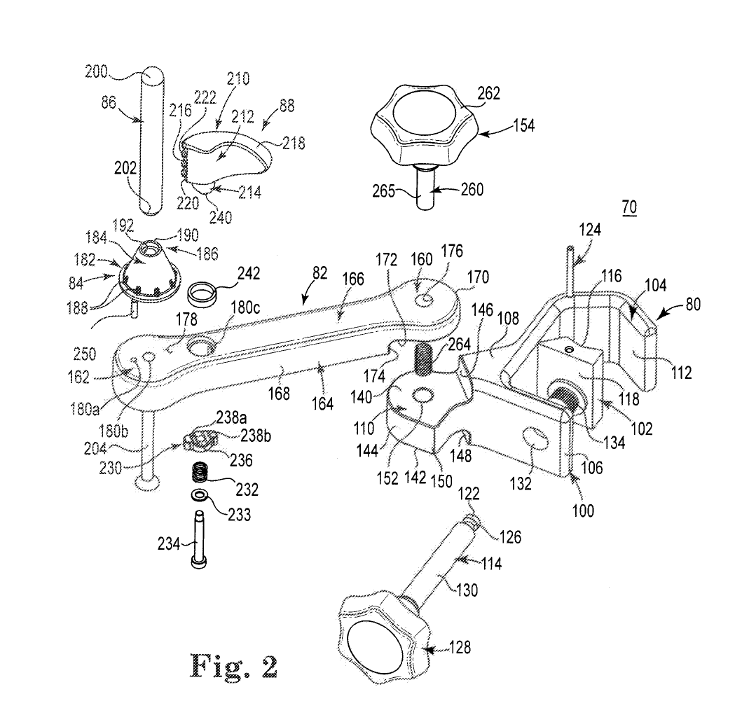

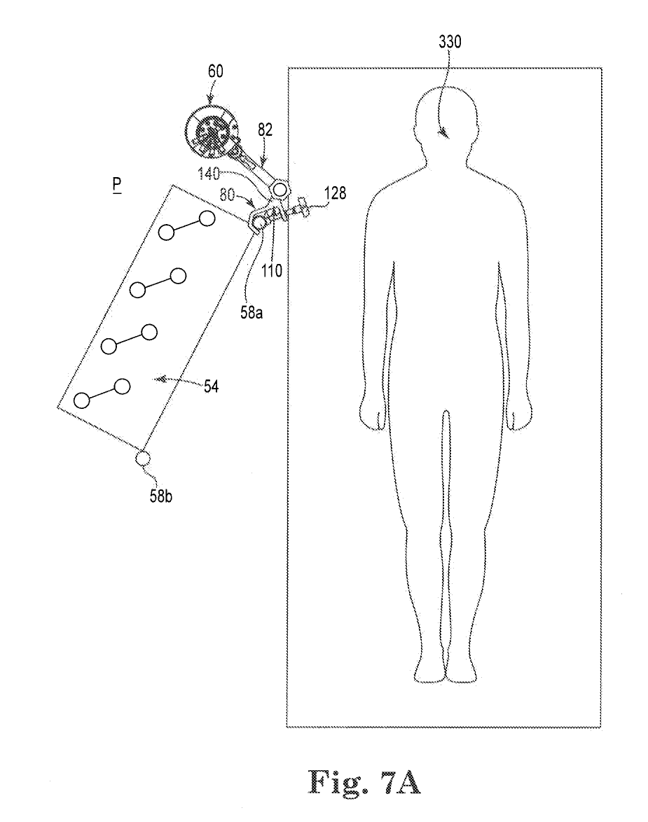

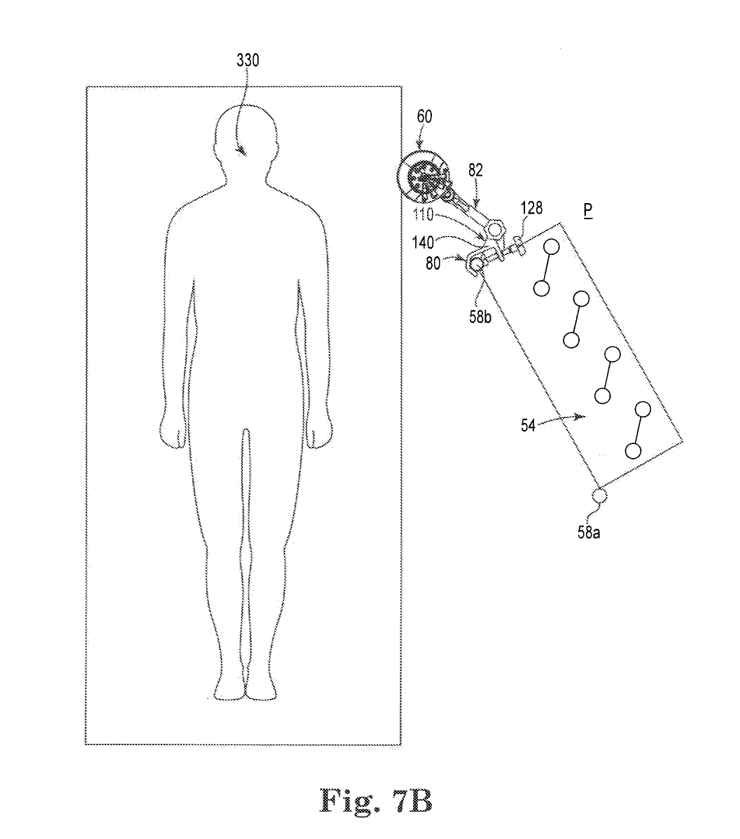

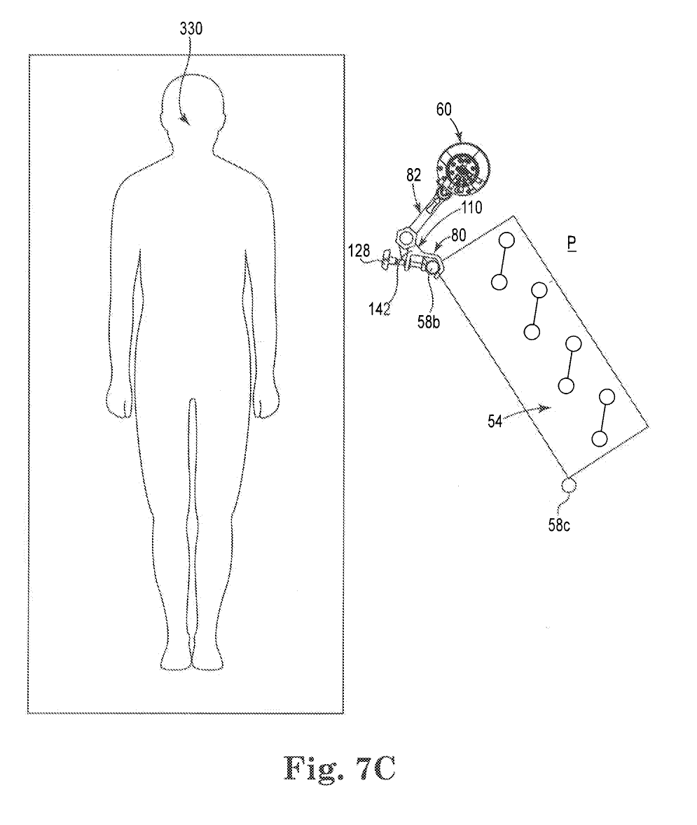

One embodiment of the holder assembly 70 is shown in greater detail in FIG. 2, and includes a clamp device 80, a primary arm 82, a seat 84, a post 86, and a locking mechanism 88 (referenced generally). Details on the various components are provided below. In general terms, however, the clamp device 80 is selectively mountable to the mast 58 (FIG. 1). The primary arm 82 is pivotably connected to the clamp device 80, with the seat 84 and the post 86 projecting from the primary arm 82 opposite the clamp device 80. Finally, the locking mechanism 88 selectively locks one or more components (e.g., one or more of the extracorporeal blood circuit components 60 (FIG. 7), the auxiliary arm 72, etc.), otherwise mounted over the seat 84, to the primary arm 82.

The clamp device 80 can assume a variety of forms appropriate for releasable coupling to the mast 58 (FIG. 1). In some constructions, however, the clamp device 80 includes a clamp body 100 and a shoe 102 moveably coupled to the clamp body 100. The clamp body 100 can form first and second arms 104, 106, a shoulder 108, and a platform 110. The first and second arms 104, 106 are laterally spaced from one another in a C-like shape, with the first arm 104 defining an interior surface 112 that is optionally shaped to accommodate the rounded exterior surface associated with a conventional, cylindrical mast or pole. Thus, for example, the interior surface 112 can have a concave curvature to provide heightened surface area contact with a cylindrical pole. Regardless, the shoe 102 is movably connected to the second arm 106 in a manner permitting the shoe 102 to be selectively moved toward and away from the first arm 104 via rotation of a shaft 114.

For example, the shoe 102 can define a mast interface surface 116 and a rear surface 118 opposite the mast interface surface 116. The mast interface surface 116 is configured to contact and engage a cylindrical mast or pole. An aperture (hidden in the view of FIG. 2) is defined in the rear surface 118 and sized to receive a leading end 122 of the shaft 114. For example, a pin 124 can be lodged within the shoe 102 and captured by the shaft 114 within a circumferential groove 126 formed adjacent the leading end 122. With this but one acceptable arrangement, the shaft 114 can rotate relative to the shoe 102 via sliding interface of the pin 124 within the groove 126, yet remain attached to the shoe 102. Further, the shaft 114 is associated with the second arm 106 such that with rotation of the shaft 114 (e.g., via a user-applied rotational force on a knob 128), the shaft 114, and thus the shoe 102, linearly translates toward or away from the first arm 104. For example, an exterior surface 130 of the shaft 114 can be threaded, and can threadably engage internal threads formed along a bore 132 in the second arm 106. Alternatively, an internally threaded bushing insert 134 can be provided (e.g., an ACME insert); with this construction, the insert 134 is press-fit within the bore 130 and threadably engages the shaft 114. A wide variety of other construction (e.g., quick release, spring-loaded, etc.), can alternatively be employed for selectively moving the shoe 102 relative to the first arm 104.

The shoulder 108 is interposed between the arms 104, 106 and the platform 110, and establishes an angular direction of extension of the platform 110. As described below, the platform 110 is coupled to the primary arm 82, with the primary arm 82 desirably extending generally away from the first arm 104 of the clamp body 100.

The platform 110 is configured to receive the primary arm 82 in a rotatable fashion as described in greater detail below. In general terms, the platform 110 extends from the shoulder 108, and defines opposing, first and second bearing surfaces 140, 142 and a perimeter edge 144. As shown, a thickness of the platform 110 is, in some constructions, less than that of the shoulder 108, with the platform 110 being generally centered relative to a thickness of the shoulder 108 to define opposing, first and second side walls 146, 148. The perimeter edge 144 is generally curved to facilitate guided articulating motion of the primary arm 82 along the edge 144. In some embodiments, the edge 144 optionally forms a nose 150 that, upon final assembly, interfaces with a corresponding feature of the primary arm 82 to prevent or stop overt movement. Finally, the platform 110 optionally can form a passage 152 or any other feature that facilitates coupling with the primary arm 82 via a connector mechanism 154 (referenced generally) described below (e.g., a threaded piece can be press-fitted within the passage 152).

Regardless of exact form, by approximately centering the platform 110 relative to the clamp body 100 and providing the opposing bearing surfaces 140, 142, the clamp device 80 is effectively reversible relative to the primary arm 82. More particularly, the primary arm 82 can be assembled to the first bearing surface 140 as shown (i.e., the clamp body 100 is arranged with the first bearing surface 140 facing up); alternatively, the clamp body 100 can be inverted from the orientation of FIG. 2, with the primary arm 82 being assembled to the second bearing surface 142 (i.e., the clamp body 100 is arranged with the second bearing surface 142 facing up). Alternatively, the clamp device 80 can incorporate additional features, or can have a more simplistic form.

The primary arm 82 defines a first end region 160, an opposing second end region 162, and an intermediate region 164 extending between the end regions 160, 162. In general terms, the first end region 160 is configured for pivotable coupling to the clamp device 80, whereas the second end region 162 is configured to retain the seat 84 and the locking mechanism 88. The intermediate region 164 contributes to an overall length of the primary arm 82 that, in some constructions, is on the order of 10-24 inches. Other lengths are also envisioned. The primary arm 82 can be akin to a hollow frame or beam, defined by an upper wall 166 and a depending flange 168 that extend across the regions 160-164. Other configurations (e.g., solid block, I-beam, etc.), are also contemplated.

The first end region 160 terminates at an end 170 that, in some constructions, is curved or rounded, and can include a cut-out 172 in the flange 168 that creates a ledge 174. As described below, this construction promotes pivoting articulation of the primary arm 82 relative to the clamp device 80, with the ledge 174 serving as a stop to overt movement. Further, the first end region 160 provides one or more features that facilitate assembly to the clamp device 80, such as an aperture 176 in the wall 166 that is sized to receive a corresponding component of the connector mechanism 154. Alternatively, the first end region 160 can incorporate additional or other features that facilitate coupling with the clamp device 80.

The second end region 162 can assume various forms, and is generally configured to provide a support surface 178 (e.g., an outer face of the upper wall 166) for locating the seat 84 and the locking mechanism 88, as well as a separate structure placed over the seat 84. In some embodiments, the second end region 162 can form one or more holes 180a-180c that promote coupling of other mounting system components as described below.

The seat 84 is a generally conically shaped body defining a base 182, an intermediate section 184, and a head 186. The base 182 can have a ring-like construction (e.g., uniform outer diameter), and is configured for flush abutment against the support surface 178. The intermediate section 184 projects upwardly (relative to the orientation of FIG. 2) from the base 182 to the head 186, and defines a tapering outer diameter (i.e., the intermediate section 184 tapers in outer diameter from the base 182 to the head 186). In some constructions, a plurality of circumferentially spaced ribs 188 are formed along, and project outwardly from, the intermediate section 184 immediately adjacent the base 182. As made clear below, the ribs 188 combine with other features to inhibit rotation of a component otherwise assembled over the seat 84. Alternatively, the ribs 188 can be omitted. Finally, the head 186 is configured to promote attachment of the post 86 with the seat 84. For example, in some constructions, the seat 84 is hollow, with an opening 190 being defined at the head 186. Further, an internal ledge 192 is formed, and is sized and shaped to support an end of the post 86. The seat 84 can alternatively incorporate other features that facilitate coupling of the post 86. In fact, in some embodiments, the seat 84 and the post 86 can be integrally formed as a unitary, homogenous body.

The post 86 is a cylindrical body, defining opposing, leading and trailing ends 200, 202. The leading end 200 can have the rounded shape illustrated to promote placement of a structure over the leading end 200; alternatively, the leading end 200 can be flat or nearly flat. Regardless, the trailing end 202 is configured for assembly to the head 186 of the seat 84, and thus can be sized in accordance with the opening 190. In some constructions, the post 86 is mounted to the seat 84 via a threaded rod 204, with the post 86 forming a threaded, internal bore (not shown) adapted to threadably receive the rod 204. Other mounting constructions are also envisioned.

The locking mechanism 88 is retained by the primary arm 82 and includes, in some constructions, a lever 210 including a lever body 212 and a neck 214. The neck 214 extends from the lever body 212, with the lever body 212 defining a leading face 216 and a trailing handle 218. The neck 214 facilitate rotatable coupling of the lever 210 to the primary arm 82.

The leading face 216 defines a primary surface or plane 220 and a plurality of fingers 222. The fingers 222 project transversely outwardly from the primary surface 220, and are vertically spaced from one another (relative to an upright orientation of the lever 210). While the lever 210 is depicted in FIG. 2 as providing four of the fingers 222, any other number, either greater or lesser, is also acceptable. Regardless, a vertical spacing between adjacent ones of the fingers 222 is identical in some embodiments, and bears a known relationship with features associated with components being assembled to the holder assembly 70.

As indicated above, the lever 210 is rotatably coupled to the primary arm 82 via the neck 214. For example, in some constructions, the locking mechanism 88 further includes a ramp body 230, a biasing device 232, an optional washer 233 and a rod 234. The rod 234 couples the ramp body 230 to the neck 214, with the biasing device 232 (e.g., a spring) biasing the ramp body 230 into engagement with the neck 214. The ramp body 230 forms a notch 236 and opposing guide surfaces 238a, 238b. Upon final assembly of the locking mechanism 88 to the primary arm 82, the neck 214 projects through the third hole 180c, and the ramp body 230 is biased or pressed into engagement with a cam surface 240 formed by the neck 214. A bushing 242 is optionally provided to promote a rotational relationship between the neck 214 and the third hole 180c, and serves to retain the ramp body 230 relative to the primary arm 82 (e.g., the ramp body 230 does not rotate with rotation of the lever 210). A shape of the cam surface 240 corresponds with a shape of the notch 236 such that the cam surface 240 naturally resides within the notch 236 due to the bias applied by the biasing device 232. In this natural or normal state or position, the leading face 216, and thus the fingers 222, is immediately adjacent and faces the seat 84. The lever 210 can be rotated or articulated from this normal state via a turning force applied to the trailing handle 218. When a sufficient moment force is applied to the lever body 212, and thus the neck 214, the cam surface 240 is rotationally displaced from the notch 236 and moves or slides along the guide surfaces 238a, 238b. With rotation of the lever 210, then, the leading face 216, and thus the fingers 222, are rotationally displaced from the seat 84. When the moment force is reduced or removed, the biased interface of the ramp body 230 with the cam surface 240 causes the lever 210 to move back toward the normal state or position described above. The locking mechanism 88 can alternatively incorporate other components/constructions that do not employ the rotatable lever 210 in selectively locking a circuit component to the seat 84. For example, a torsion spring-based latch or similar mechanism can be used.

Construction of the holder assembly 70 includes assembling the seat 84 and the post 86 to the primary arm 82. For example, the trailing end 202 of the post 86 is lodged within the head 186 of the seat 84, and the threaded rod 204 employed to secure the post 86 to the seat 84, as well as the post 86 (and thus the seat 84) to the primary arm 82 via the second hole 180b. A pin 250 can also be employed, interconnecting the seat 84 with the primary arm 82 via the first hole 180a. The pin 250 essentially serves to impede or prevent rotation of the seat 84 relative to the primary arm 82. Finally, the locking mechanism 88 is assembled to the primary arm 82 as described above.

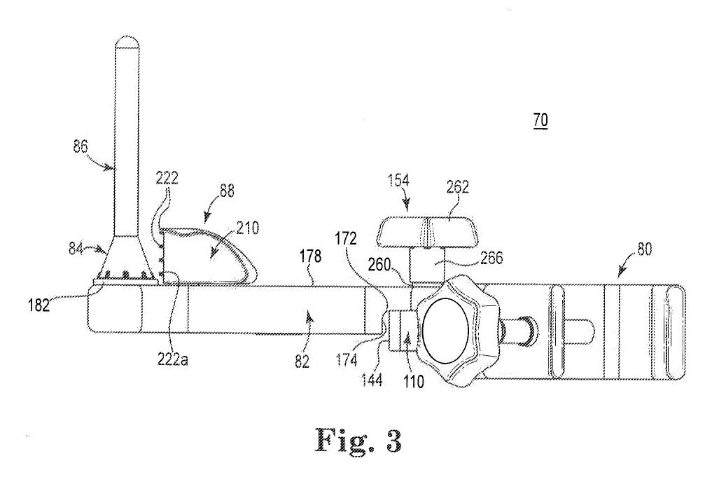

As shown in the final assembled state of FIG. 3, the post 86 projects in a generally perpendicular fashion relative to the support surface 178, with the fingers 222 of the lever 210 facing toward the seat 84 in the normal state of locking mechanism 88. As illustrated, the fingers 222 project substantially parallel to the support surface 178, with a bottom-most finger 222a being slightly above (relative to the orientation of FIG. 3) a height of the seat base 182. With this construction, the holder assembly 70 can selectively receive and retain one or more various other components placed over the post 86 and the seat 84, such as the auxiliary arm 72 (FIG. 2). For example, a capturing zone is established between the bottom-most finger 222a and the support surface 178. As a point of clarification, rotation of the lever 210 from the normal (or locked) state of FIG. 3 results in the lever 210 moving upwardly relative to the support surface 178 (as the cam surface 240 (FIG. 2) rides along the guide surfaces 238a, 238b (FIG. 2)), thereby lifting the fingers 222 upwardly away from the support surface 178 in a released state of the locking mechanism 88.

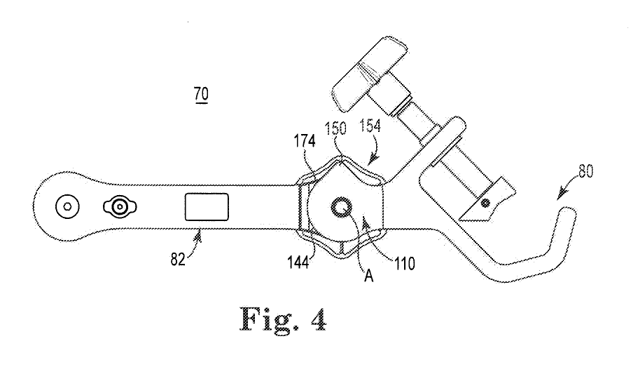

Returning to FIG. 2, the primary arm 82 is rotatably coupled to the clamp device 80 via, in some embodiments, the connector mechanism 154 that can include a shaft 260 terminating at a knob 262, as well as an optional threaded insert 264. The shaft 260 is slidably received through the aperture 176 in the first end region 160 of the primary arm 82, and is selectively coupled to the platform 110 of the clamp device 80 via the passage 152. For example, the threaded insert 264 (e.g., a helicoil insert) is press-fitted into the passage 152. A threaded exterior surface 265 of the shaft 260 threadably engages the internal threads formed by the insert 264. Alternatively, other components and/or mechanisms can be employed to effectuate coupling of the primary arm 82 and the clamp device 80. Upon tightening/screwing of the shaft 260 to the platform 110, the primary arm 82 is effectively locked relative to the platform 110 via a hub 266 extending from the knob 262 as best shown in FIG. 3. With loosening/unscrewing of the shaft 260 from the platform 110, the primary arm 82 is readily articulatable relative to the platform 110. The perimeter edge 144 nests within the cut-out 172 of the primary arm 82, and slides along the ledge 174 with pivoting movement of the primary arm 82, as reflected in FIG. 4 (i.e., in a released state of the connector mechanism 154, the primary arm 82 can be rotated relative to the platform 110 about an axis A). Overt movement of the primary arm 82 is prevented by engagement of the nose 150 with the ledge 174. In other embodiments, this rotational stop feature can be omitted.

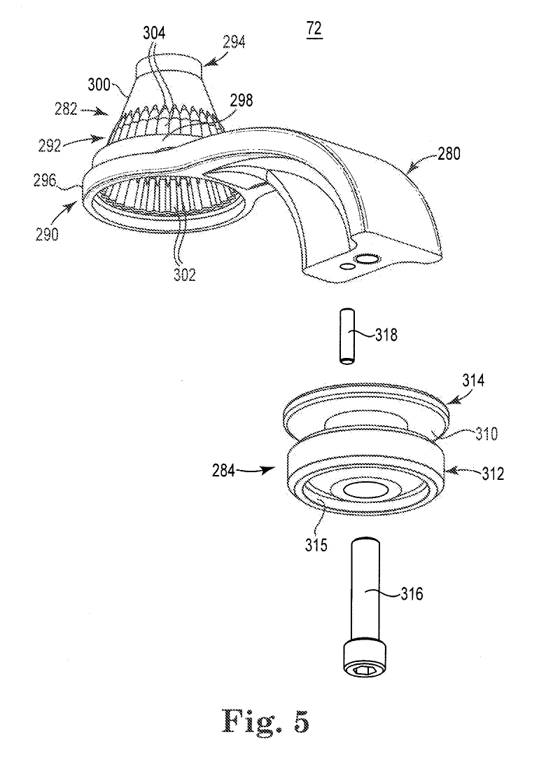

Returning to FIG. 1, the auxiliary arm 72 is configured to be selectively mountable to the holder assembly 70. One embodiment of the auxiliary arm 72 is shown in FIG. 5, and includes an arm body 280 extending between a sleeve 282 and a grasping structure 284. In some constructions, the auxiliary arm 72 is configured to releasably retain a separate extracorporeal blood circuit disposable component, such as an oxygenator (not shown). The arm body 280 can be curved as shown (e.g., curving downwardly from the sleeve 282 to the grasping structure 284); alternatively, the arm body 280 can be linear, can incorporate a plurality of bends, etc.

The sleeve 282 is configured to interface with the holder assembly 70 (FIG. 2), and in particular the seat 84 (FIG. 2) and the post 86 (FIG. 2). The sleeve 282 can have a generally conical shape corresponding with that of the seat 84, and is defined by a bottom portion 290, an intermediate portion 292, and a top portion 294. With additional reference to FIG. 2, the bottom portion 290 has a generally ring shape, defining an inner diameter and height corresponding with an outer diameter of the base 182 of the seat 84. Thus, the bottom portion 290 can nest over the base 182 and provides an exterior rim 296.

The intermediate portion 292 includes or forms a hub 298 and a guide region 300. The hub 298 has a uniform outer diameter in some embodiments, and is akin to the base 182 of the seat 84. The guide region 300 defines a tapering diameter corresponding with a taper of the intermediate section 184 of the seat 84 (i.e., the inner and outer diameters of the guide region 300 taper in extension from the hub 298 to the top portion 294 in accordance with a taper of the intermediate section 184). In some constructions, the guide region 300 further includes or defines internal grooves 302 and external teeth 304. The internal grooves 302 are circumferentially spaced from one another, and each define a width corresponding with a width of respective ones of the ribs 188 provided with the seat 84. Thus, the internal grooves 302 can selectively receive respective ones of the ribs 188 in a meshing-type interface upon assembly of the sleeve 282 over the seat 84. The external teeth 304 are also circumferentially spaced from one another, and provide for a similar, meshed-type interface with a similarly-configured sleeve otherwise included with a separate component (i.e., the internal grooves 302 of a second, identically-configured sleeve (not shown) coaxially disposed over the sleeve 282 will engage with the external teeth 304). Finally, the top portion 294 is configured to slidably receive the post 86, and thus defines an opening (hidden in the view of FIG. 5) sized in accordance with a diameter of the post 86.

The grasping structure 284 can assume a variety of forms appropriate for selectively receiving and retaining a separate component, such as an extracorporeal blood circuit component (not shown). For example, in some constructions, the grasping structure 284 is a disk-like body, defining a circumferential slot 310 separating opposing first and second disks 312, 314. A width of the slot 310 corresponds with a thickness of a feature provided with the circuit component to be assembled to the auxiliary arm 72, with the disks 312, 314 serving to frictionally retain the component relative to the grasping structure 284 and/or the first disk 312 is frictionally received by the component feature. In some constructions, the first disk 312 can optionally further form an inner groove 315 sized to selectively capture a corresponding feature of the circuit component to be assembled to the auxiliary arm 72. Regardless, sliding rotation of the component along or about the slot 310 can occur. The grasping structure 284 can be assembled to the arm body 280 in a variety of manners, such as via a bolt 316 that couples the grasping structure 284 to the arm body 280, and a pin 318 that serves to prevent rotation of the grasping structure 284 relative to the arm body 280 upon a design of final assembly.

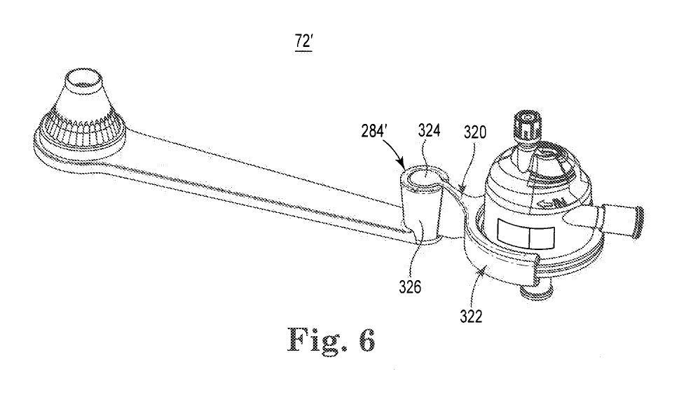

Depending upon the particular component to be retained by the auxiliary arm 72, the grasping structure 284 can alternatively assume a wide variety of other constructions and/or incorporate other devices or mechanisms. For example, the grasping structure 284 can include a clamp mechanism. Alternatively, and as shown with the auxiliary arm 72′ of FIG. 6, the grasping structure 284′ can be configured to receive and retain a separate connector 320 that in turn is coupled to an extracorporeal circuit disposable component 60 (e.g., an arterial filter). The connector 320 can have a snap ring structure 322 for engaging the disposable component 60, and a column 324 slidably received within a slotted shell 326 formed by the grasping structure 284′. A variety of other, differently configured connectors can also be mounted to the slotted shell 326 so long as the column 324 is included with the connector design.

Returning to FIG. 1, the mounting system 52 can be used with a number of differently configured perfusion systems 50. During use, and with reference to FIG. 7A, the cart 54 is positioned at a location relative to the patient as desired by the surgical team. The clamp device 80 is then coupled to one of the masts 58, followed by mounting of the primary arm 82 to the clamp device 80 (it being understood that the primary arm 82 can be loosely coupled to the clamp device 80 prior to mounting of the clamp device 80 to the mast 58). In this regard, while connection of the primary arm 82 to the clamp device 80 permits pivoting of the primary arm 82 over a relatively large angle and the clamp body 100 extends outwardly from the mast 58, an orientation of the clamp device 80 relative to the cart 54 can be selected as desired by the perfusionist based upon a position of the cart 54 relative to the patient. For example, in FIG. 7A, the cart 54 is located to a right-hand side of the patient 330. With this arrangement, the perfusionist may desire to locate disposable, extracorporeal blood circuit disposable components to the left of the cart 54 (as a point of reference, the normal location of the perfusionist relative to the front of the cart 54 in the arrangement of FIG. 7A is labeled generally as “P”). With this in mind, the clamp device 80 is coupled to the left mast 58a, with the first bearing surface 140 facing upwardly as shown. The primary arm 82 is then connected to the clamp device 80, and naturally extends (via the angled orientation of the platform 110) toward the perfusionist to locate one or more circuit components 60 conveniently at the perfusionist's desired location P relative to the cart 54.

Conversely, FIG. 7B illustrates a different surgical suite arrangement in which the cart 54 is located to a left-hand side of the patient 330. With this arrangement, the right mast 58b is implicated. While the clamp device 80 could be assembled to the right mast 58b with the first bearing surface 140 facing upwardly as shown, the platform 110 would naturally locate the primary arm 82 (and the circuit component(s) 60 retained thereon) away from the desired perfusionist's location P. Further, the knob 128 is facing the desired perfusionist location P and may obstruct the perfusionist's field of view. Thus, while the arrangement of FIG. 7B is viable, it can present ergonomical concerns for the perfusionist. Instead, with the mounting system 52 of the present disclosure, the clamp device 80 can be inverted as shown in FIG. 7C, and coupled to the right mast 58b with the second bearing surface 142 facing upwardly. With this orientation, coupling of the primary arm 82 to the platform 110 extends the primary arm 82 toward the desired perfusionist's location P, and thus promotes easy interface by the perfusionist with the circuit component(s) 60 held by the primary arm 82. Further, the knob 128 is located away from the perfusionist's location P.

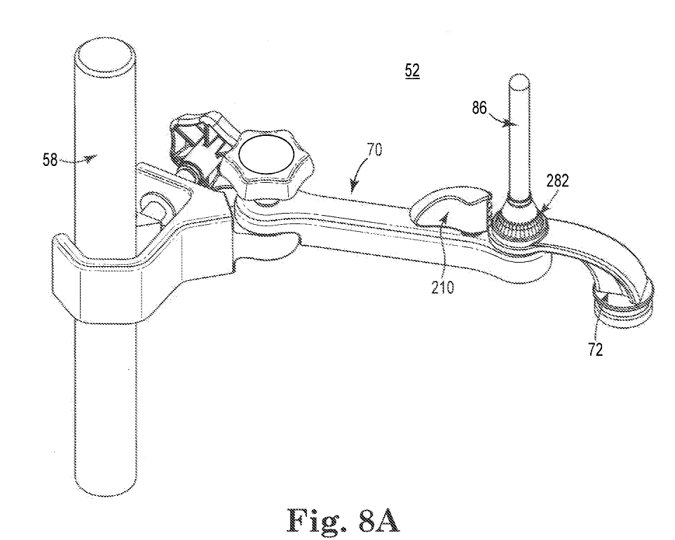

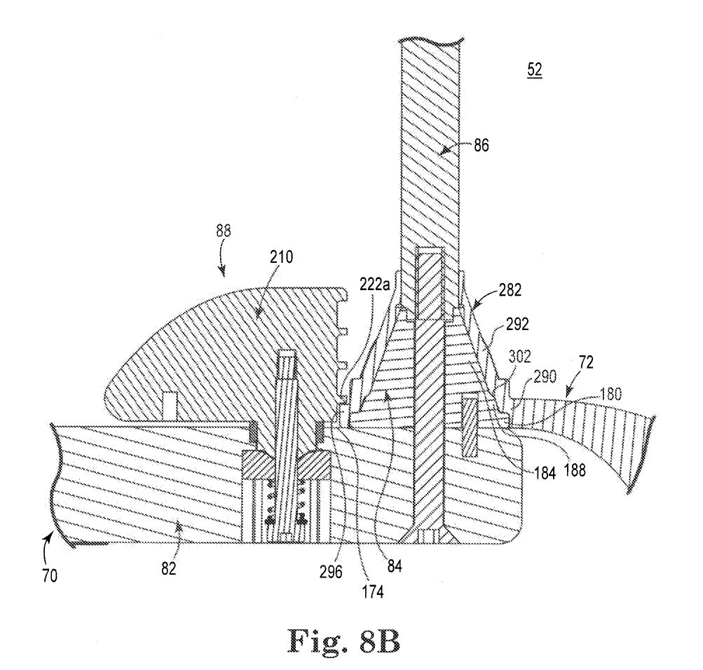

Once the holder assembly 70 is coupled to the selected mast 58, one or more extracorporeal blood circuit components can be mounted to the holder assembly 70. For example, and as shown in FIGS. 8A and 8B, the auxiliary arm 72 as described above is mounted to the holder assembly 70. In particular, the sleeve 282 is coaxially positioned over the post 86, and then moved onto the seat 84. The bottom portion 290 nests over the base 180 of the seat 84, and the tapered intermediate portion 292 abuts the intermediate section 184. The locking mechanism 88 secures or locks the auxiliary arm 72 relative to the primary arm 82. In particular, and as best shown in FIG. 8B, in the locked state of the locking mechanism 88, the exterior rim 296 of the sleeve 282 is captured between one of the fingers 222 (in particular, the bottom-most finger 222a) and the support surface 174 of the primary arm 82. The meshed interface between the ribs 188 of the seat 84 and the internal grooves 302 of the sleeve 282 further inhibit rotation of the sleeve 282 about the seat 84.

To permit rotation of the auxiliary arm 72 relative to the primary arm 82 and/or complete removal from the holder assembly 70, the lever 210 can be rotated as described above, such that the bottom-most finger 222a no longer bears against the rim 296. In this released state of the locking mechanism 88, the auxiliary arm 82 can be rotated about an axis of the post 86 to virtually any desired spatial rotational orientation relative to the primary arm 82 as desired by the user/perfusionist. Once in the desired rotational arrangement, the auxiliary arm 72 is manipulated to position the sleeve 282 on the seat 84 as described above, and the locking mechanism 88 returned to the locked state.

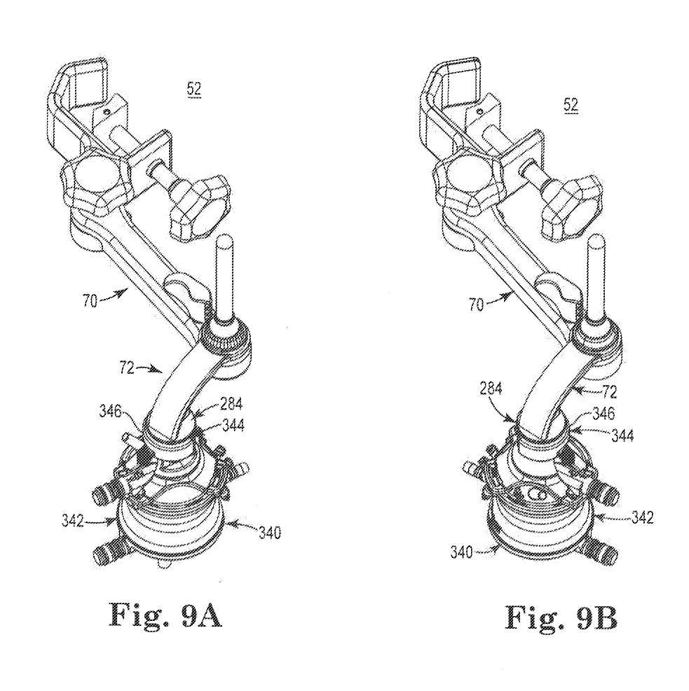

The desired extracorporeal blood circuit component 60 (FIG. 1) can then be mounted to the auxiliary arm 72 (or can be mounted to the auxiliary arm 72 prior to assembly of the auxiliary arm 72 to the holder assembly 70). For example, FIG. 9A illustrates one construction of an extracorporeal circuit component in the form of an oxygenator 340 including a housing 342 and a connector 344. The oxygenator includes additional components conventionally employed for perfusion oxygenators, such as a heat exchanger, fiber bundle, ports, valves, hemoconcentrators, cardioplegia disposables, etc. Regardless, the connector 344 forms a C-shaped body 346 that is slidably received by, and frictionally retained within, the circumferential slot 310 (FIG. 5) of the grasping structure 284 (and/or the first disk 312 (FIG. 5) of the grasping structure 284 is frictionally retained by the C-shaped body 346). It will be understood that the oxygenator 340 is but one example of a disposable extracorporeal blood circuit component that can be mounted to the auxiliary arm 72. Other components, such as filters, etc., are also envisioned, with the grasping structure 284 assuming a format useful for interfacing with the disposable component. With the but one acceptable configuration of the grasping structure 284 described above, however, interface between the grasping structure 284 and the connector 344 allows the oxygenator 340 to be rotated relative to auxiliary arm 72 as reflected by a comparison of FIGS. 9A and 9B. This optional feature facilitates positioning of the oxygenator 340 on either side of the cart 54 (FIG. 1), enhancing the universal nature of the mounting system 52

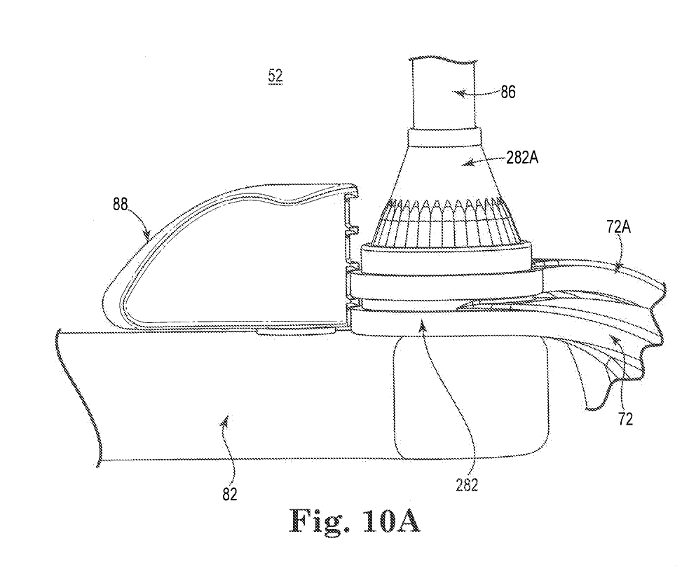

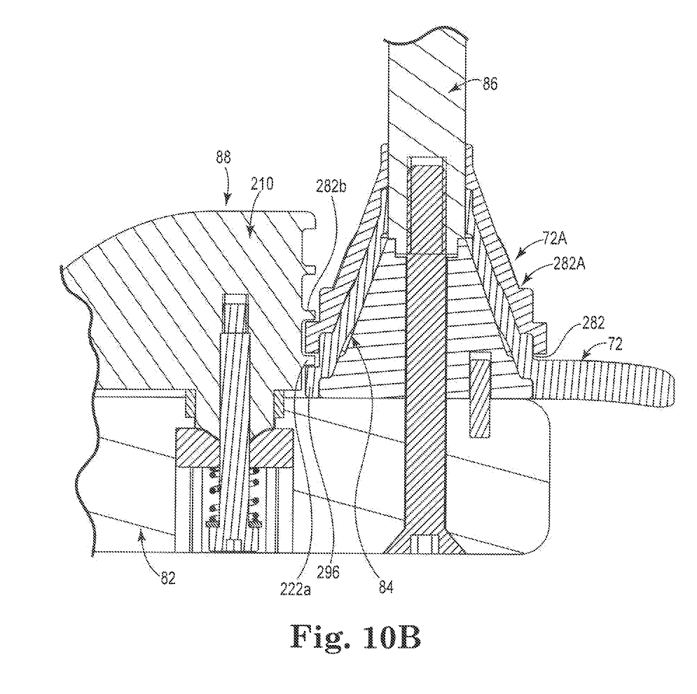

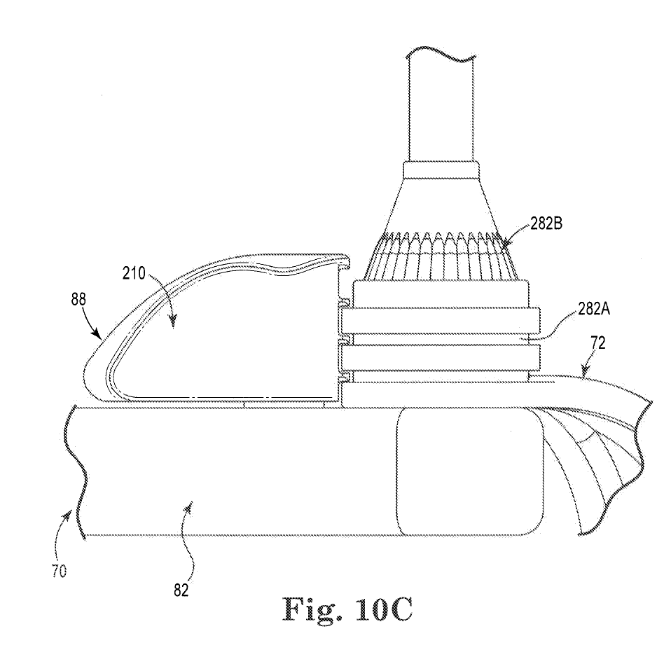

Returning to FIGS. 7A and 7B, one or more additional components can be mounted to the holder assembly 70. For example, as shown in FIG. 10A, a second auxiliary arm 72A can be employed, with the corresponding sleeve 282A being slid over the post 86 and onto the sleeve 282 of the first auxiliary arm 72. The first and second auxiliary arms 72, 72A can be rotated about an axis of the post 86 to any desired rotational position relative to the primary arm 82 independent of one another. Once desired arrangement of the auxiliary arms 72, 72A is achieved, the locking mechanism 88 is again operated to more robustly secure the arms 72, 72A to the primary arm 82.

For example, and as shown in FIG. 10B, in the locked state, the bottom-most finger 222a captures the rim 296 of the first sleeve 282. The sleeve 282A of the second auxiliary arm 72A is similarly captured between the bottom-most finger 222a and an immediately adjacent, intermediate finger 222b. As further reflected in FIG. 9C, one or more additional sleeves 282B (and thus additional auxiliary arms) can be further stacked onto the holder assembly 70, with the locking mechanism 88 selectively securing the sleeves 282-282B to the primary arm 82. When desired, the lever 210 is simply rotated from the position of FIG. 10C, thereby releasing the sleeves 282-282B relative to the primary arm 82.

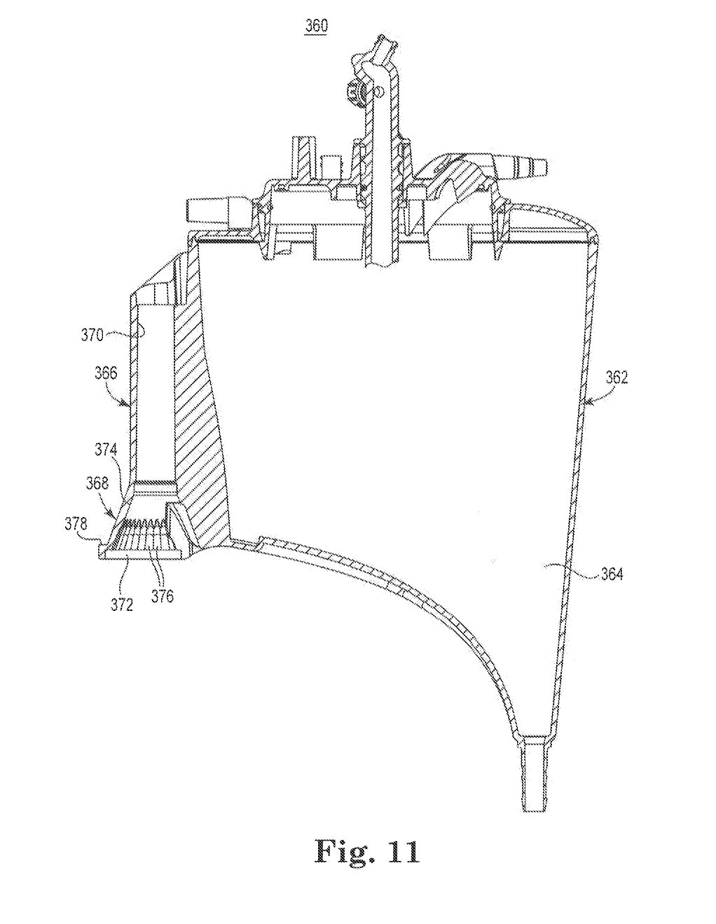

In addition, or as an alternative to the auxiliary arm 72 being assembled to the holder assembly 70, correspondingly configured disposable extracorporeal blood circuit components can be directly mounted over the post 86. For example, FIG. 11 generally illustrates one embodiment of a blood reservoir 360 in accordance with principles of the present disclosure and useful as part of an extracorporeal blood circuit system. The blood reservoir 360 generally includes a housing 362 forming one or more chambers 364 and a mounting portion 366. The blood reservoir 360 will include additional components as known in the art for collection and optionally de-foaming of blood, such as venous and/or cardiotomy suctioned blood. Regardless, the mounting portion 366 forms a foot 368 and defines a passage 370 extending from, and open at, the foot 368. The foot 368 is akin to the sleeve 282 (FIG. 5) described above, and includes a bottom region 372 and an intermediate region 374. The passage 370 along the bottom region 372 has a generally uniform diameter, corresponding with an outer diameter of the base 182 of the seat 84 (FIG. 2) as well as the bottom portion 290 (FIG. 5) of the sleeve 282 (FIG. 5). The passage 370 tapers in diameter from the bottom region 372 along the intermediate region 374, with the intermediate region 374 optionally forming a plurality of circumferentially spaced internal grooves 376. Finally, the foot 368 forms an exterior lip 378.

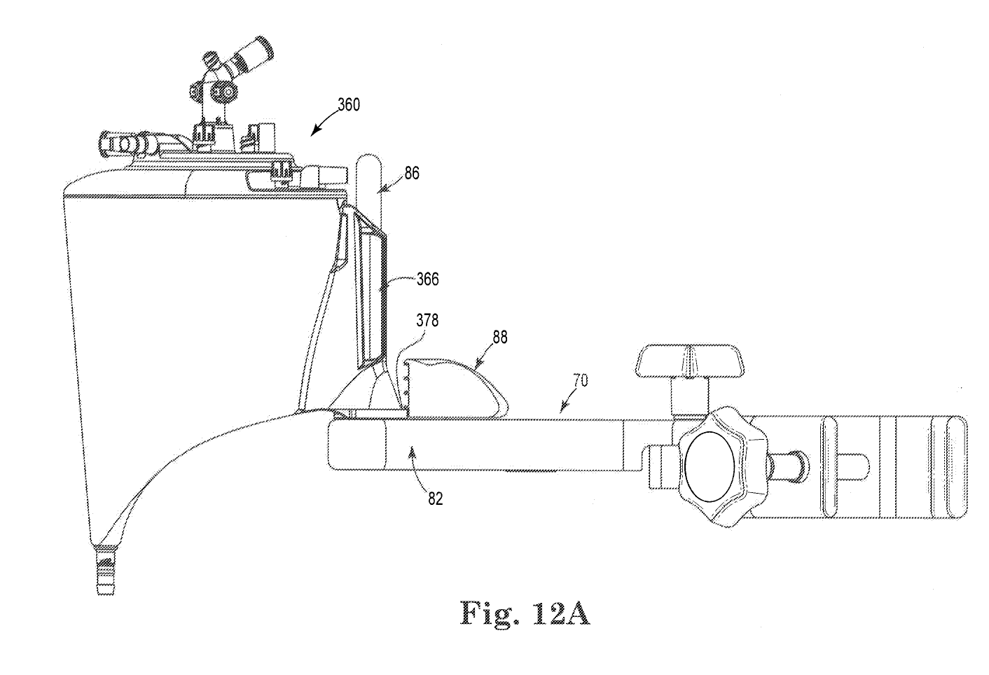

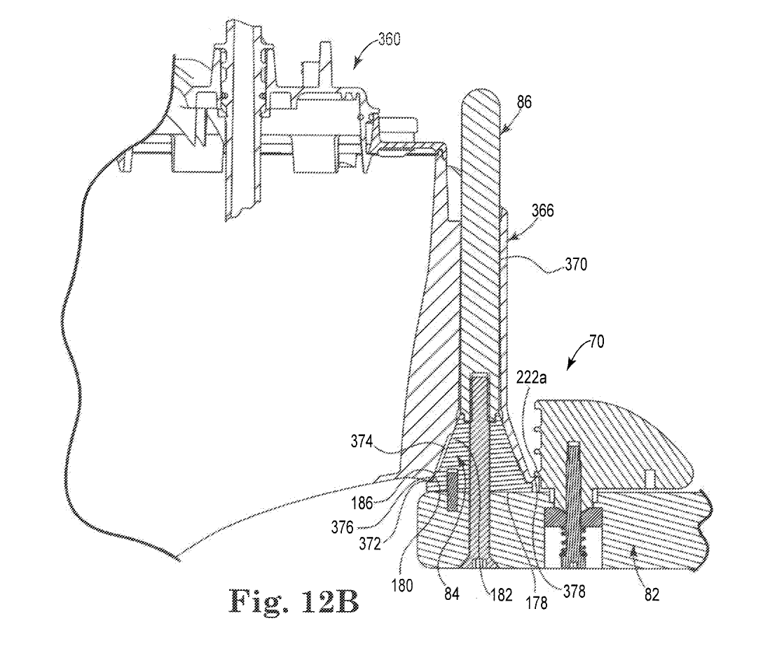

The above-described blood reservoir 360 (or any other extracorporeal blood circuit disposable component incorporating the mounting portion 366 as described) can be directly assembled to the holder assembly 70 and onto the seat 84 as shown in FIGS. 12A and 12B. The post 86 is received within the passage 370, with the bottom region 372 residing over the base 180 and the intermediate region 374 abutting the intermediate section 182 of the seat 84. The ribs 186 engage within respective ones of the grooves 376 to inhibit rotation of the blood reservoir 360 relative to the seat 84. Finally, in the locked state of the locking mechanism 88, the bottom-most finger 222a captures the lip 378 of the mounting portion 366 against the support surface 178 of the primary arm 82. Conversely, in the released state of the locking mechanism 88, the blood reservoir 360 can freely rotate about an axis of the post 86 to a spatial arrangement desired by the perfusionist.

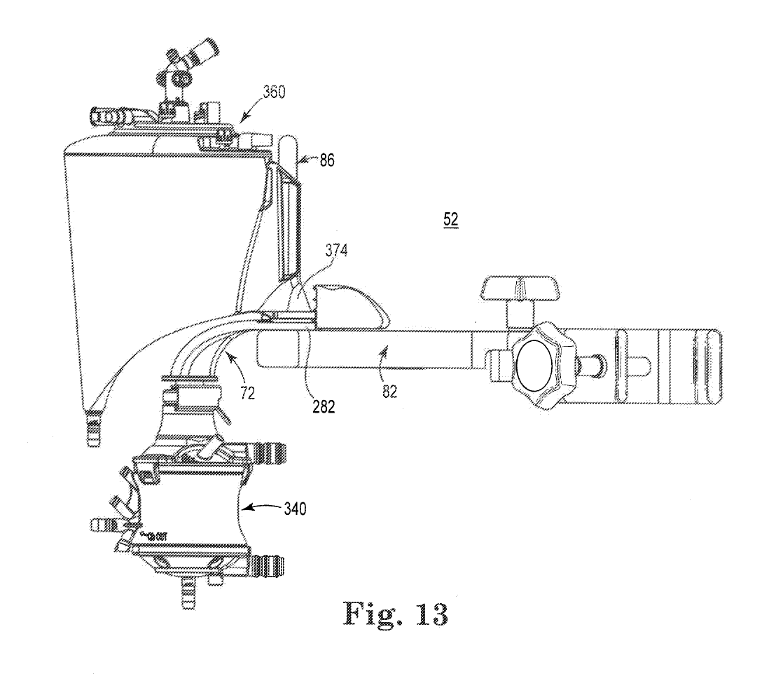

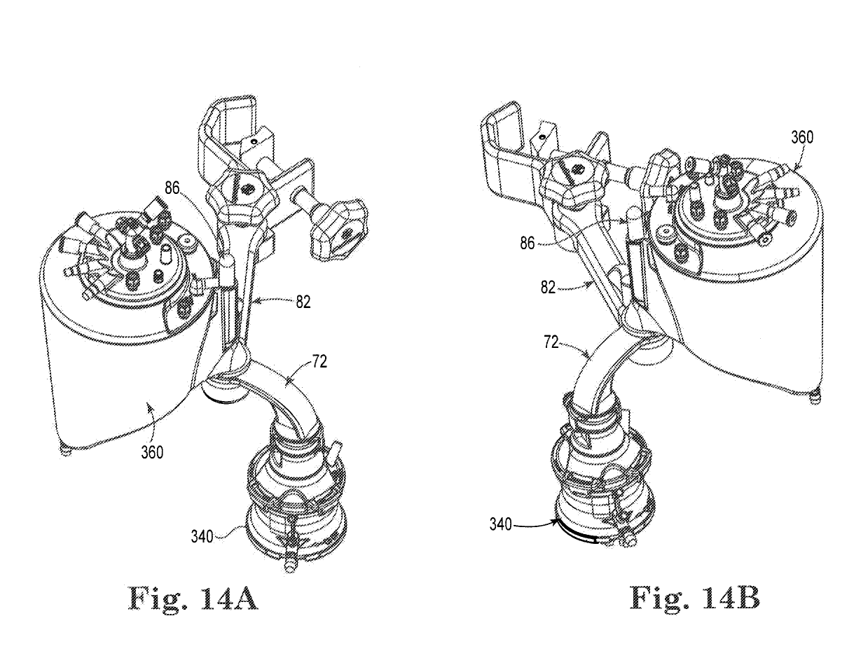

Alternatively, the blood reservoir 360 (or any other extracorporeal circuit disposable component incorporating the mounting portion 366 as described) can be assembled over the post 86 and onto the previously-mounted auxiliary arm 72 as shown in FIG. 13. In general terms, the intermediate region 374 of the passage 370 (referenced generally) is disposed over the guide region 300 (FIG. 5) of the sleeve 282, with the external teeth 304 (FIG. 5) of the sleeve 282 being received within individual ones of the internal grooves 376 (FIG. 11). With this arrangement, the blood reservoir 360 and the auxiliary arm 72 (and thus the disposable circuit component mounted to the auxiliary arm 72), can be rotated independently of one another to any desired spatial position about an axis of the post 86. For example, as shown in FIG. 13, the oxygenator 340, otherwise mounted to the auxiliary arm 72, can be located directly below the blood reservoir 360. Alternatively, and as reflected in FIGS. 14A and 14B, the blood reservoir 360 and the oxygenator 340 can be rotationally or spatially separated from one another and independently spatially arranged as described. In more general terms, then, the perfusionist can quickly position and re-position the blood reservoir 360 and the oxygenator 340 (and any other disposable circuit component mounted over the post 86) as desired.

The extracorporeal blood circuit component mounting systems and methods of the present disclosure provide a marked improvement over previous designs, and facilitate flexible positioning of a plethora of different extracorporeal disposable components such as oxygenators, blood reservoirs, filters, hemoconcentrators, centrifugal pumps, etc. The mounting systems and methods are ergonomic and intuitive to use, facilitate desirable ambidextrous positioning of various components, and effectively allow the perfusionist to create a customized circuit in accordance with the circumstances presented by each particular surgical procedure.

Although the present disclosure has been described with reference to preferred embodiments, workers skilled in the art will recognize that changes can be made in form and detail without departing from the spirit and scope of the present disclosure.

What is claimed is:

1. A mounting system for mounting one or more components of an extracorporeal blood circuit to an upstanding mast provided with a cart maintaining one or more pumps employed with the extracorporeal blood circuit, the mounting system comprising:
a clamp device configured for releasable mounting to an upstanding mast;
a primary arm defining opposing first and second end portions, wherein the first end portion is pivotably coupled to the clamp device;
a seat defining a base, an intermediate section, and a head, wherein the base is mounted to the second end portion of the primary arm, and further wherein the intermediate section is conical, tapering in outer diameter from the base to the head, and is configured to receive a corresponding surface associated with an extracorporeal blood circuit component;
a post projecting from the head; and
a locking mechanism for releasably securing an extracorporeal blood circuit component over the seat and to the primary arm.

2. The mounting system of claim 1, wherein the base defines a height having a non-tapering outer diameter.

3. The mounting system of claim 2, wherein the seat further includes a plurality of circumferentially spaced ribs projecting from the intermediate section immediately adjacent the base.

4. The mounting system of claim 1, wherein the locking mechanism includes a lever rotatably coupled to the primary arm.

5. The mounting system of claim 4, wherein the lever defines a leading face and a trailing handle, and further wherein the lever is rotatably transitionable between a locked state in which the leading face is immediately adjacent and faces the seat, and a released state in which the leading face is rotationally displaced from the seat.

6. The mounting of claim 5, wherein the leading face defines a primary plane, and a plurality of spaced fingers projecting transversely outwardly from the primary plane.

7. The mounting system of claim 6, wherein the plurality of fingers includes a bottom-most finger located to capture a feature associated with a first extracorporeal blood circuit component otherwise received over the seat between the bottom-most finger and the primary arm in the locked state.

8. The mounting system of claim 7, wherein the plurality of fingers further includes an intermediate finger immediately adjacent and vertically spaced from the bottom-most finger, and further wherein a distance between the bottom-most finger and the intermediate finger corresponds with a thickness of a feature associated with a second extracorporeal blood circuit component such that in the locked state, the locking mechanism captures the feature of the second extracorporeal blood circuit component otherwise disposed on the feature of the first extracorporeal blood circuit component between the bottom-most and the intermediate fingers.

9. The mounting system of claim 6, wherein the locking mechanism further includes a biasing device and is configured such that the biasing device biases the lever toward the primary arm.

10. The mounting system of claim 9, wherein the locking mechanism further includes a cam body and a ramp surface, the cam body being coupled to a neck of the lever and slidably interfacing with the ramp surface, and further wherein the ramp surface, the cam body, and the biasing device are configured to bias the lever toward the locked state.

11. The mounting system of claim 1, further comprising:
an auxiliary arm forming a leading region and a sleeve;
wherein the sleeve is configured to be removably assembled over the seat.

12. The mounting system of claim 11, wherein the sleeve includes a conical portion sized and shaped to be removably disposed over the intermediate section of the seat.

13. The mounting system of claim 12, wherein the seat includes a plurality of outwardly projecting, circumferentially spaced ribs along the intermediate section, and the sleeve forms a plurality of circumferentially spaced internal grooves, and further wherein the grooves are sized to selectively receive respective ones of the ribs to impede rotation of the auxiliary arm relative to the primary arm upon final assembly.

14. The mounting system of claim 13, wherein the sleeve and the seat are configured to provide at least first and second assembled states in which the sleeve is received over the seat and the ribs mesh with the grooves, and further wherein a spatial position of the auxiliary arm relative to the primary arm in the first assembled state is different from the second assembled state.

15. The mounting system of claim 11, wherein the leading region forms a grasping body configured to selectively receive and retain a feature of an extracorporeal blood circuit component.

16. The mounting system of claim 15, wherein the grasping body forms a circumferential slot defined by opposing disks.

17. An assembly for use in an extracorporeal blood circuit, the assembly comprising:
a blood reservoir including a housing forming a chamber and a mounting region, the mounting region defining a foot and a passage, wherein the passage is open at, and extends from, the foot; and
a mounting system comprising:
a clamp device configured for releasable mounting to an upstanding mast,
a primary arm defining opposing first and second end portions, wherein the first end portion is pivotably coupled to the clamp device,
a seat defining a base, an intermediate section, and a head, wherein the base is mounted to the second end portion of the primary arm, and the intermediate section tapers in outer diameter from the base to the head and is configured to receive the foot of the blood reservoir,
a post projecting from the head,
a locking mechanism for releasably securing the blood reservoir to the primary arm;
wherein upon mounting of the blood reservoir to the mounting system, the blood reservoir is selectively rotatable relative to the primary arm about an axis of the post such that the assembly is configured to provide first and second lock states in which the post is received within the passage and the foot is locked over the seat via the locking mechanism, wherein a spatial orientation of the blood reservoir relative to the primary arm differs between the first and second locked states.

18. The assembly of claim 17, wherein the locking mechanism is configured to provide an unlocked state in which the foot is partially received over the seat and the blood reservoir is freely rotatable relative to the primary arm about an axis defined by the post.

19. The assembly of claim 17, wherein:
the seat includes a plurality of circumferentially spaced ribs projecting from the intermediate section immediately adjacent the base; and
the foot forms a plurality of circumferentially spaced internal grooves sized to selectively receive respective ones of the ribs for inhibiting rotational movement of the blood reservoir relative to the primary arm in the locked state.

20. The assembly of claim 17, wherein the locking mechanism includes a lever rotatably coupled to the primary arm.

21. The assembly of claim 20, wherein the lever defines a leading face having a primary plane and a bottom-most finger projecting transversely outwardly from the primary plane, and further wherein in a first position of the lever relative to the conical seat, the foot is captured between the bottom-most finger and the primary arm.

22. The assembly of claim 21, wherein the locking mechanism further includes a biasing device and is configured such that the biasing device biases the lever toward the primary arm.

23. The assembly of claim 21, wherein the lever further includes an intermediate finger immediately adjacent and vertically spaced from the bottom-most finger, the assembly further comprising:
an auxiliary arm defining a sleeve sized to be selectively received over the seat;
wherein the assembly is configured to provide a stacked mounting state in which the sleeve is received over the seat and the foot is received over the sleeve, the sleeve being captured between the bottom-most finger and the primary arm, and the foot being captured between the intermediate finger and the bottom-most finger in a locked state of the locking mechanism.

24. The mounting assembly of claim 23, wherein the auxiliary arm further includes a leading region opposite the sleeve, the leading region forming a grasping structure, the assembly further comprising:
an oxygenator including a housing forming a connector defining a slot;
wherein the slot is sized to slidably receive the grasping structure.

25. The assembly of claim 24, wherein the assembly is configured such that:
the blood reservoir is selectively retained by the mounting system at a multiplicity of different spatial orientations about an axis of the post relative to the primary arm; and
the oxygenator is selectively retained by the mounting system at a multiplicity of different spatial orientations about an axis of the post relative to the primary arm, the spatial orientation of the oxygenator being independent of the spatial orientation of the blood reservoir.

26. A method of arranging components of an extracorporeal blood circuit, the method comprising:
coupling a clamp device of a mounting system to an upstanding pole provided with a cart maintaining at least one pump to be used in the extracorporeal blood circuit, the mounting system further including a primary arm pivotably coupled to the clamp device, a seat carried by the primary arm, a post projecting from the seat, and a locking mechanism;
assembling a blood reservoir to the mounting system, the blood reservoir including a housing forming a mounting section defining a foot and a passage, wherein assembly of the blood reservoir includes sliding the passage over the post;
rotating the blood reservoir relative to the primary arm about an axis of the post to a first desired reservoir spatial orientation; and
locking the blood reservoir relative to the primary arm in the first desired reservoir spatial orientation via operation of the locking mechanism.

27. The method of claim 26, wherein locking the blood reservoir further includes:
placing the foot into direct contact with the seat.

28. The method of claim 27, wherein locking the blood reservoir relative to the primary arm further includes capturing the foot between the primary arm and a finger carried by the lever of the locking mechanism.

29. The method of claim 26, further comprising:
unlocking the blood reservoir relative to the primary arm;
rotating the blood reservoir relative to the primary arm to a second desired reservoir spatial orientation differing from the first desired reservoir spatial orientation; and
locking the blood reservoir relative to the primary arm in the second desired reservoir spatial orientation.

30. The method of claim 26, wherein the mounting system further includes an auxiliary arm defining a sleeve and a grasping structure, the method further comprising:
assembling the sleeve over the post;
connecting a second extracorporeal blood circuit component separate from the blood reservoir to the grasping structure;
rotating the auxiliary arm relative to the primary arm about an axis of the post; and
locking the auxiliary arm relative to the primary arm via the locking mechanism.

31. The method of claim 30, wherein the steps of rotating the blood reservoir and rotating the auxiliary arm are performed independently of one another.

32. The method of claim 30, wherein assembling the blood reservoir and assembling the auxiliary arm includes:
disposing the sleeve directly over the seat; and
disposing the foot directly over the sleeve.

33. The method of claim 32, wherein the locking mechanism includes a lever forming a bottom-most finger and an intermediate finger, and further wherein locking the blood reservoir and the auxiliary arm includes:
rotating the lever relative to the primary arm such that the sleeve and the foot are simultaneously captured between the primary arm and the bottom-most finger, and the bottom-most finger and the intermediate finger, respectively.

34. The method of claim 32, further comprising:
mounting a third extracorporeal blood circuit component over the post.

35. The method of claim 30, wherein the second extracorporeal blood component is selected from the group consisting of an oxygenator, a filter, a hemoconcentrator, and a cardioplegia disposable.
